(19) United States
(12) Patent Application Publication
(10) Pub. No.: US 2024/0094347 A1
(43) Pub. Date: Mar. 21, 2024

(54) DEVICE FOR LASER SURVEYING OF AN ENVIRONMENT

(71) Applicant: RIEGL Laser Measurement Systems GmbH, Horn (AT)

(72) Inventors: Andreas ULLRICH, Gablitz (AT); Peter RIEGER, Grossau (AT); Rainer REICHERT, Horn (AT)

(73) Assignee: RIEGL Laser Measurement Systems GmbH, Horn (AT)

(21) Appl. No.: 18/038,521

(22) PCT Filed: Dec. 7, 2021
(86) PCT No.: PCT/EP2021/084601

§ 371 Date: May 24, 2023

(30) Foreign Application Priority Data
Dec. 11, 2020 (EP) 20213336.9

(51) Int. Cl. G01S 7/481; G01S 17/89

(52) U.S. Cl. CPC G01S 7/4815; G01S 7/4816; G01S 7/4817; G01S 17/89

(57) ABSTRACT

Device for laser surveying of an environment A device for surveying an environment by time-of-flight measurement of laser beams reflected therefrom comprises a beam deflection device having at least one mirror surface which can be rotated or oscillated about an axis of rotation which is non-normal to the mirror surface. The device further comprises a first laser transmitter with associated first laser receiver, and a second laser transmitter with associated second laser receiver. The transmission and reception directions of the first and second laser transmitters and receivers lie parallel to one another in pairs and at different angles to the axis of rotation. The first laser receiver is spaced apart from the first laser transmitter and the second laser receiver is spaced apart from the second laser transmitter, in each case in the direction of the axis of rotation.

### CROSS-REFERENCE TO RELATED APPLICATIONS

This application is a National Phase application of International Application No. PCT/EP2021/084601 filed Dec. 7, 2021 which claims priority to the European Patent Application No. 20 213 336.9 filed Dec. 11, 2020, the disclosures of which are incorporated herein by reference.

### TECHNICAL FIELD

The present disclosed subject matter relates to a device for surveying an environment by time-of-flight measurement of laser beams reflected therefrom, e.g., pulsed laser beams, comprising a beam deflection device having at least one mirror surface which can be rotated or oscillated about an axis of rotation which is non-normal to the mirror surface, which beam deflection device has a mirror prism, the prism lateral sides of which each form a mirror surface and the prism axis of which is the axis of rotation, a first laser transmitter, which is configured to emit a first transmission laser beam in a first time-dependent transmission direction via the beam deflection device, and a first laser receiver, which is configured to receive as a first reception laser beam the first transmission laser beam reflected by the environment and received back via the beam deflection device in a first time-dependent reception direction, wherein the first transmission and reception directions lie parallel to one another and at a first angle to the axis of rotation at the respective transmission and reception times of the transmission and reception laser beams.

### BACKGROUND

Devices of this type are known, for example, from EP 3 182 159 B1 and are used in particular for airborne surveying of landscapes. From a laser scanner on board an aircraft, multiple laser pulses are emitted from a high altitude by means of the beam deflection device onto many target points on the ground, and from time-of-flight measurements of the target reflections, the target distances and from these—knowing the position and location of the laser scanner and the respective deflection angle—a point model (“3D point cloud”) of the landscape are created. In the process, the transmission laser beam directed at the rotating or oscillating mirror surface(s) is periodically swivelled (“scanned”) by this or these over a scanning angle range and forms a scanning fan for sweeping the landscape. The reception laser beam reflected by the environment is received back along the same path, i.e. the mirror surface used in each case to emit a transmission laser pulse in a specific direction is simultaneously used to deflect the laser pulse received from the same direction to the laser receiver.

### BRIEF SUMMARY

Such laser scanners have to fulfil a wide range of requirements. On the one hand, it is desirable to create the point cloud as quickly and completely as possible during the survey flight, on the other hand, the survey should be as error-free as possible at the same time. Dust, humidity or clouds in the near range can cause interfering reflections which complicate the creation of the landscape model or falsify it. The aim of the disclosed subject matter is to create a device for laser scanning which enables a particularly fast and meaningful creation of a point cloud of the environment, free of near-target errors.

This aim is achieved with a device of the type mentioned at the outset, which is characterised according to the disclosed subject matter by a second laser transmitter, which is configured to emit a second transmission laser beam in a second time-dependent transmission direction via the beam deflection device, and a second laser receiver, which is configured to receive as a second reception laser beam the second transmission laser beam reflected by the environment and received back via the beam deflection device in a second time-dependent reception direction, wherein the second transmission and reception directions lie parallel to one another and at a second angle to the axis of rotation at the respective transmission and reception times of the transmission and reception laser beams, and wherein the first laser receiver is spaced apart from the first laser transmitter and the second laser receiver is spaced apart from the second laser transmitter, in each case in the direction of the axis of rotation.

The laser scanning device of the disclosed subject matter can emit two or more (see further below) divergent scanning fans simultaneously with a single beam deflection device. On the one hand, this allows twice as many measurement points of the environment to be created for the point cloud in the same time. On the other hand, if the device is moved over the environment in a feed direction that deviates from the scanning fan planes, the same point in the environment will be hit by the scanning fans at different angles in each case, so that surfaces that happen to lie in the plane of one scanning fan can also be correctly detected by another scanning fan. If, for example, in airborne surveying one scanning fan is directed in the nadir direction and the other scanning fan is directed obliquely forwards or backwards, vertical house façades can also be correctly mapped in the point cloud. At the same time, the survey is not susceptible to interference from “wrong” environment targets in the near range, such as chassis parts of an aircraft, clouds, etc., due to the parallax caused by the mutual spacing of the laser transmitters and receivers in the direction of the axis of rotation. Due to this parallax, the device can only detect targets from a certain minimum distance, which depends on the beam expansion of the transmission laser beam, the reception aperture of the laser receiver, and the aforementioned distance between transmitter and receiver.

As a result, the device of the disclosed subject matter achieves a particularly fast, complete and interference-free surveying of the environment with simple means, namely a single beam deflection device extending in the direction of the axis of rotation, along which the laser transmitters and receivers are distributed.

Optionally, the laser emitters are directed towards the beam deflection device such that the transmission laser beams cross one another substantially at the beam deflection device. The expression “substantially at the beam deflection device” means the immediate vicinity of the beam deflection device in relation to the average measurement distance of the environment. For example, in the case of an airborne laser scanner, the environment is surveyed from an altitude of several 100 metres or kilometres, and a comparatively negligible near range can be up to a few metres.

By crossing the transmission laser beams as close as possible to the beam deflection device, the points of impact of the transmission laser beams on the mirror surface(s) of the beam deflection device are as close to one another as possible, seen in the direction of the axis of rotation, so that the length of the beam deflection device in the direction of the axis of rotation can be reduced.

According to a further optional feature of the disclosed subject matter, the angular orientations of the laser transmitters and receivers and, further optionally, also the distances of the laser receivers from the beam deflection device are selected in such a way that the reception laser beams cross one another between the beam deflection device and the laser receivers. In the same way, this minimises the impingement area required for the reception laser beams on the beam deflection device in the direction of its axis of rotation. Furthermore, a common focusing optical unit can be arranged in the crossing area of the reception laser beams, so that only one focusing optical unit is required for all reception laser beams and their size can be reduced to the crossing area.

In a first optional embodiment of the disclosed subject matter, the first and second transmission and reception directions lie in a common plane parallel to the axis of rotation at the respective transmission and reception times of the transmission and reception laser beams. When the device is mounted with its axis of rotation in the feed direction of a transport platform, for example an aircraft, the scanning fans thereby overlap in the feed direction, so that one and the same locations of the environment of scanning fans can be scanned at different angles.

In a second optional embodiment of the disclosed subject matter, the laser transmitters and laser receivers are oriented in such a way that, between the beam deflection device and the environment, those transmission and reception laser beams which, viewed away from the beam deflection device, approach one another are skewed relative to one another. This increases the near-range insensitivity and thus the susceptibility to interference of the device. Without this measure, it could be that the transmission laser beam of a laser transmitter is reflected by a near target, for example a cloud, in the reception direction of a laser receiver assigned to another laser transmitter and thus leads to faulty points in the point cloud.

In a first possible variant, the mirror prism has a groove running around its periphery, wherein, viewed in the direction of the prism axis, the laser transmitters lie to one side of the groove and the laser receivers to the other side of the groove. In a second possible variant, the mirror prism has a rib running around its periphery, wherein, viewed in the direction of the prism axis, the laser emitters lie to one side of the rib and the laser receivers to the other side of the rib. This can significantly increase the selectivity of the near-range insensitivity of the device. Interfering scattering of the transmission laser beams into the reception laser beams in the near range of the device is additionally blocked by this groove or rib.

In both variants, viewed in the direction of the prism axis, the laser receivers optionally lie at a greater distance from the groove or rib than the laser transmitters. In other words, a large part of the longitudinal extent of the mirror prism is made available for the impingement area of the reception laser beams, so that a large reception aperture can be used and thus the device has a high measuring sensitivity and thus a high measuring range. At the same time, the longitudinal portion of the mirror prism used for the transmission laser beams is minimised so that the mirror prism has a reduced length.

The device according to the disclosed subject matter can be extended with the stated principles to any number of laser transmitters and receivers, for example three, four, five, etc., each directed towards the beam deflection device at different angles. Accordingly, a further optional embodiment of the disclosed subject matter is characterised by a third laser transmitter, which is configured to emit a third transmission laser beam in a third time-dependent transmission direction via the beam deflection device, and a third laser receiver, which is configured to receive as a third reception laser beam the third transmission laser beam reflected by the environment and received back via the beam deflection device in a third time-dependent reception direction, wherein the third transmission and reception directions lie parallel to one another and at a third angle to the axis of rotation at the respective transmission and reception times of the transmission and reception laser beams, and wherein the third laser receiver is spaced apart from the third laser transmitter in the direction of the axis of rotation.

For the detection of vertical surfaces or façades in an overflown terrain, it is favourable if the first transmission and reception directions with the second transmission and reception directions, and also the second transmission and reception directions with the third transmission and reception directions, form an angle, in each case at the respective transmission and reception times of the transmission and reception laser beams, in the range of 1° to 30°, optionally 5° to 15°, e.g., 5° to 10°.

If it is also optionally provided that all mirror surfaces are parallel to the axis of rotation and the second transmission and reception directions are normal to the axis of rotation, this results—with a horizontal movement of the device relative to the environment that is not in the scanning fan plane—in a first scanning fan in the nadir direction, a second scanning fan in an oblique forward direction, and a third scanning fan in an oblique backward direction. This allows point clouds of overflown buildings with vertical surfaces to be created particularly well.

In each of the aforementioned embodiments, it is advantageous if the beam deflection device has at least one compensation mirror in the beam path of the reception laser beams to the laser receivers, which can be adjusted about an adjustment axis parallel to the axis of rotation. Such a compensation mirror can be used to compensate for the time offset, and thus the directional offset, of the mirror surface(s) of the beam deflection device, which elapses between the emission of a laser pulse from the beam deflection device until its return reception at the beam deflection device. During this time, the corresponding mirror surface has already rotated a little further, and thus it would “look” in a different direction for the reception laser beam than it “sent” for the transmission laser beam. This directional offset depends on the measuring distance and the angular velocity of the mirror surface and can be compensated accordingly by the compensation mirror. The transmission and reception directions of the associated laser transmitters and receivers can thus be kept constantly parallel to one another regardless of the angular velocity and the measuring distance, which simplifies the set-up considerably. However, it is understood that instead of a compensation mirror, the laser receivers could also be slightly angularly adjusted with respect to the laser transmitters or parts of the transmission deflection device assigned to them, which is subsumed here under the term “substantially parallel transmission and reception directions of the laser transmitters and receivers”.

It is favourable if a common compensation mirror is provided for all reception laser beams. Since said directional offset is the same for all reception laser beams, such a single compensation mirror can be used, thus simplifying the construction of the device.

As discussed, a possible form of application of the device of the disclosed subject matter is that it is mounted on an aircraft configured for a main direction of flight with its axis of rotation non-normal to the main direction of flight, optionally substantially parallel to the main direction of flight.

### BRIEF DESCRIPTION OF THE DRAWINGS

The Disclosed Subject Matter is Explained in Greater Detail Below with Reference to Exemplary Embodiments Shown in the Accompanying Drawings. The Drawings Show:

FIG. 1 the device of the disclosed subject matter mounted on an aircraft for surveying a landscape;

FIG. 2 one of the transmission and reception channels of the device of FIG. 1 in a block diagram with schematically drawn beam paths;

FIGS. 3 and 4 the device of FIG. 1 without the housing, once in a front view seen in the direction of the axis of rotation (FIG. 3) and once in a side view (FIG. 4), in each case with schematically drawn beam paths; and

FIG. 5 the parallax of the laser transmitter and receiver in a transmission/reception channel of the device of FIG. 1 in a side view as in FIG. 4 with schematically drawn beam paths.

### DETAILED DESCRIPTION

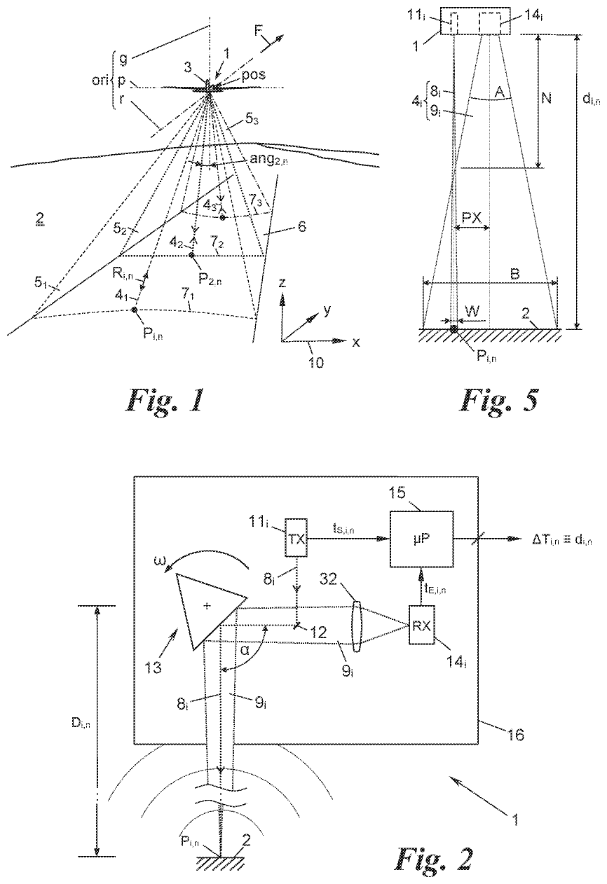

FIG. 1 shows a device 1 for surveying an environment 2 from a vehicle 3. The environment 2 to be surveyed can be, for example, a landscape (terrain), but also the road surface and the façades along a road, the inner surface of a hall, a tunnel or mine, or the sea surface or sea floor, etc. The vehicle 3 can be a land, air or water vehicle, manned or unmanned.

The device 1 scans the environment 2 by means of two or more (here: three) laser measuring beams 4₁, 4₂, 4₃, generally 4ᵢ (i=1, 2, . . . ), for the purpose of surveying it. Each laser measuring beam 4ᵢ is pivoted back and forth to form a respective scanning fan 5ᵢ and is moved forward in the direction of travel F of the vehicle 3 to scan the environment 2 in adjacent scanning strips 6 (only one shown). If the vehicle 3 is an aircraft, the direction of travel F is the main direction of flight of the aircraft for which it is built.

The direction of travel F does not lie in the planes of the scanning fans 5ᵢ. In the case shown, the direction of travel F is normal to the plane of the scanning fan 5₂, so that the scanning fan 5₂ lies in the nadir direction of the vehicle 3 and the scanning fan 5₃ is directed obliquely forwards and the scanning fan 5₁ is directed obliquely backwards downwards towards the environment 2. However, the scanning fans 5ᵢ can also be rotated, for example, about a vertical axis g of the vehicle 3, so that their lines of intersection 7ᵢ with the environment 2, the “scan rows”, in the scan strip 6 lie obliquely to the projected direction of travel F. In the same way, the scanning fans can be rotated about a pitch axis p and/or roll axis r of the vehicle 3.

The scanning fans 5ᵢ are not necessarily planar. For example, due to the deflection mechanism of the laser measurement beams 4ᵢ discussed later, the backward and forward scanning fans 5₁, 5₃ lie on weakly curved cone surfaces; see the exemplary curvatures of the scan line 7₁, 7₃. This is negligible for the purposes of the present disclosed subject matter; the terms “planar” scanning fans 5ᵢ and “scanning fan planes” of the scanning fans 5ᵢ are understood in the present description to include such weakly curved scanning fans.

Each laser measurement beam 4ᵢ comprises a transmission laser beam 8ᵢ from the device 1 to the environment 2 and a reception laser beam 9ᵢ reflected by said environment back to the device 1. From time-of-flight measurements of laser pulses S_{i,n} (n=1, 2, . . . ), which are contained in the respective transmission laser beam 8ᵢ and are each reflected at a point P_{i,n} of the environment 2 and are received back as environment-reflected laser pulses E_{i,n} in the reception laser beams 9ᵢ in the device 1, distance measurement values d_{i,n} from a current position pos_{i,n} of the device 1 to the respective scanning point P_{i,n} of the environment 2 can be calculated using the known relationship

d_{i,n}=c·ΔTP_{i,n}/2=c·(t_{E,i,n}−t_{S,i,n})/2 (1)

with
t_{S,i,n} . . . . . . transmission time of the transmission laser pulse S_{i,n} of the transmission laser beam 8ᵢ,
t_{E,i,n} . . . . . . reception time of the reception laser pulse E_{i,n} of the reception laser beam 9ᵢ, and
c . . . . . . speed of light.

Knowing the respective position pos_{i,n} of the device 1 at the time of emission of the laser pulse S_{i,n} in a local or global x/y/z coordinate system 10 of the environment 2, the respective orientation ori_{i,n} of the device 1 in the coordinate system 10, indicated for example by the tilt, roll and yaw angles of the vehicle 3 about its transverse, longitudinal and vertical axes p, r, g, and the respective angular position ang_{i,n} of the laser measurement beam 4ᵢ in the direction of the point P_{i,n} with respect to the vehicle 3, the position of the scanning point P_{i,n} in the coordinate system 10 can then be calculated from the respective distance measurement value d_{i,n}. A multitude of such surveyed and calculated scanning points P_{i,n} image the environment 2 in the form of a “scanning point cloud” in the coordinate system 10.

FIG. 2 shows the time-of-flight measurement principle of the device 1 in one of the three transmission/reception channels of the device 1, each of which is responsible for a scanning fan 5ᵢ. The same principle is applied for each transmission/reception channel, i.e. for each scanning fan 5ᵢ, of the device 1.

According to FIG. 2, the transmission laser pulses S_{i,n} in the i^{th} transmission/reception channel are emitted by a laser transmitter 11ᵢ via a mirror 12 and a deflecting device 13, for example an oscillating mirror, a rotating polygon mirror wheel, a rotating mirror pyramid or a rotating mirror prism, as a transmission laser beam 8ᵢ, are received back after reflection at the respective ambient point P_{i,n} on the same path via the deflecting device 13 as ambient-reflected or reception laser pulses E_{i,n} in the form of a reception laser beam 9ᵢ and are incident on a laser receiver 14ᵢ. The transmission times t_{S,i,n} of the laser pulses S_{i,n} and the reception times t_{E,i,n} of the laser pulses E_{i,n} reflected from the environment are fed to a measuring device 15, which uses them to calculate the respective distance d_{i,n} using equation (1).

The pulse repetition rate (PRR) of the transmission laser pulses S_{i,n} is constant or can be modulated, for example to resolve MTA (multiple time around) ambiguities, in order to facilitate the assignment of reception pulses E_{i,n} and transmission pulses S_{i,n} to one another, as known in the art.

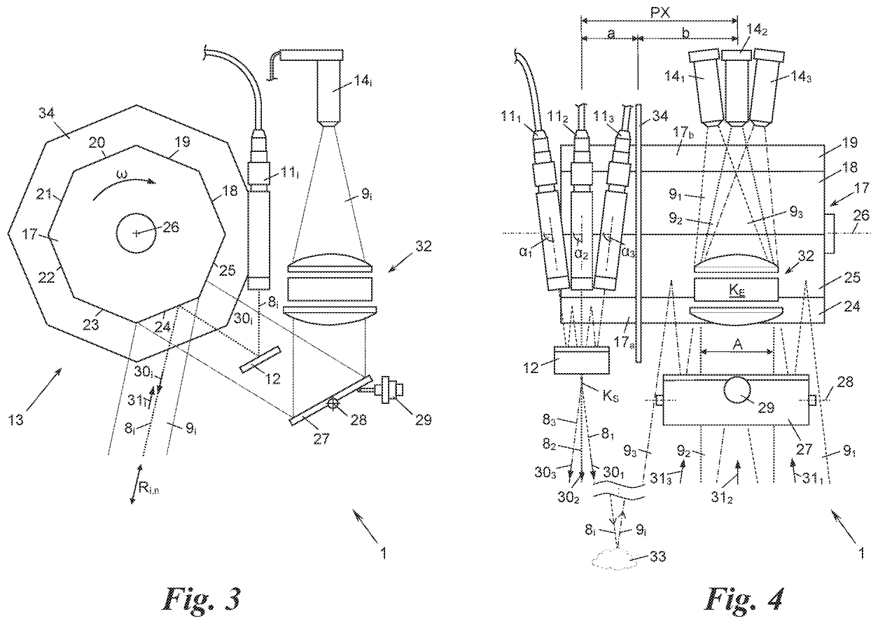

FIGS. 3 and 4 show the mechanical and optical components of all three transmission/reception channels of the device 1. The housing 16 (FIG. 2) of the device 1, which stores all these components, is removed in FIGS. 3 and 4 for clarity.

In the example of FIGS. 3 and 4, the beam deflection device 13 for all transmission/reception channels is a common mirror prism 17, the prism lateral sides 18-25 of which each form a mirror surface for deflecting the transmission and reception laser beams 8ᵢ and 9ᵢ and the prism axis of which is the axis of rotation 26 about which the mirror surfaces 18-25 rotate. The mirror prism 17 can have any number of prism lateral sides and thus mirror surfaces 18-25, for example three, four, etc., and can be a regular or irregular prism. Accordingly, the prism lateral sides or mirror surfaces 18-25 may all have the same size and equal distances to the prism axis 26 or also may not.

The mirror prism 17 rotates with an angular velocity ω. Due to the time of flight ΔT_{i,n} of a laser pulse emitted by the device 1 as a transmission laser pulse S_{i,n} and received back in the device 1 as a reception laser pulse E_{i,n}, the beam deflection device 13 continues to move at the angular velocity ω during the time of flight ΔT_{i,n}, so that the corresponding mirror surface 19-25 (here: 24) no longer has the same position when the reception laser beam 9ᵢ is received. In order to nevertheless be able to receive the corresponding reception laser pulse E_{i,n} in the laser receiver 14ᵢ from exactly the orientation R_{i,n} of the transmission laser beam 8ᵢ when measuring the ambient point P_{i,n} with the transmission laser pulse S_{i,n}, the beam deflection device 13 additionally has a compensation mirror 27 which can be adjusted about an adjusting axis 28 parallel to the axis of rotation 26 by means of an actuator 29. The actuator 29 can be controlled, for example, by the angular velocity co and the current average target distance d_{i,n} of the last measured points P_{i,n} in order to compensate for the aforementioned effect.

Instead of using a compensation mirror 27, the aforementioned angular offset between the transmission laser beam 8ᵢ and the reception laser beam 9ᵢ, which depends on the angular velocity ω and the current average target distance d_{i,n}, could also be achieved by a corresponding angular offset between the respective laser transmitter 11ᵢ and its associated laser receiver 14ᵢ, for example by a swivel bearing of the laser transmitter 11ᵢ and/or laser receiver 14ᵢ about the axis of rotation 26, which swivel bearing is adjusted by the actuator 29. In a further variant, a longitudinal portion 17ₐ of the mirror prism 17 used for the laser transmitters 11ᵢ could be angularly rotated relative to a longitudinal portion 17_{b} of the mirror prism 17 used for the laser receivers 14i, for example by the longitudinal portions 17ₐ, 17_{b} being mounted on a common shaft so as to be angularly rotatable relative to one another about the axis of rotation 26, in order to compensate for the aforementioned angular offset between the transmission and reception laser beams 8ᵢ, 9ᵢ. The angular offset between the two longitudinal portions 17a, 17_{b} of the mirror prism 17 is again adjusted for this purpose by the actuator 29 depending on the angular velocity ω of the mirror prism 17 and the current average target distance d_{i,n}.

For each transmission/reception channel i, i.e. for each scanning fan 5ᵢ, the device 1 comprises in each case a laser transmitter 11ᵢ and an associated laser receiver 14ᵢ, i.e. in the example shown the laser transmitter and laser receiver pairs {11, 14₁₁}, {11, 14₂₂} and {11, 14₃₃}. The transmission direction 30ᵢ of the device 1 for a laser transmitter 11ᵢ is in each case substantially parallel to the reception direction 31ᵢ of the device 1 for the laser receiver 14ᵢ of the laser transmitter and laser receiver pair responsible for the respective scanning fan 5ᵢ, more specifically in each case viewed at the transmission time t_{S,i,n} (the “transmission time”) and associated reception time t_{E,i,n} (the “reception time”) of the transmission and reception laser pulses S_{i,n} and E_{i,n} in the transmission and reception laser beams 8ᵢ and 9ᵢ respectively. The angular offset by the compensation mirror 27 or the mutual rotation of the laser transmitters and laser receivers 11ᵢ, 14ᵢ or of corresponding longitudinal portions 17ₐ, 17_{b} of the mirror prism 17 about the axis of rotation 26 compensates here for the further rotation of the deflection device 13 during the pulse time of flight d_{i,n}.

The transmission directions 30ᵢ of all laser transmitters 11ᵢ lie—viewed at the respective transmission and reception times of the transmission and reception laser beams 8ᵢ, 9ᵢ—in each case at a different angle αᵢ to the axis of rotation 26 and thus to the mirror surfaces 18-25 used in each case; see FIG. 4. The same applies to the reception directions 31ᵢ of the laser receivers 14ᵢ—which are thus parallel in pairs.

The angle α₁-α₂ between the transmission direction 301 of the first laser transmitter 11₁ and the transmission direction 30₂ of the second laser transmitter 11₂ as well as the angle α₂-α₃ between the transmission direction 30₂ of the second laser transmitter 11₂ and the transmission direction 30₃ of the third laser transmitter 11₃—and thus also the respective angles between the reception directions 31₁, 31₂, 31₃—is—again considered at the respective transmission and reception times of the transmission and reception laser beams 8ᵢ, 9ᵢ—for example in each case 1° to 30°, optionally 5° to 15°, e.g., 5° to 10°, and for example approximately 7°.

It is understood that the laser emitters 11ᵢ and laser receivers 14ᵢ could also be directed directly at the mirror surfaces 18-25 of the deflection device 13 instead of via the deflection and compensation mirrors 12, 27, or via several deflection and/or compensation mirrors.

The laser transmitters 11, and the respective associated laser receivers 14, are spaced apart from one another as seen in the direction of the axis of rotation 26, i.e. have a parallax PX in the direction of the axis of rotation 26. As a result, the laser receivers 14, are insensitive, or “blind” so to speak, to reflections of the transmission laser beams 8ᵢ on surrounding targets located in a near range N from the device 1, for example chassis parts of the vehicle 3, clouds, etc.

As shown in FIG. 5, the size N of this near range, in which the device 1 is insensitive to measurement targets, depends on the parallax PX, the unavoidable beam widening W of the bundled emitted transmission laser beams 8ᵢ as well as the reception aperture A of the laser receivers 14ᵢ. The reception aperture A, i.e. the angle of view of the laser receivers 11 is determined in the example of FIGS. 3 and 4 by the intersection formed of the size of the mirror surfaces 18-25, the size of the compensation mirror 27, the aperture of a focusing optical unit 32 located in the beam path of each reception laser beam 9ᵢ and the size of the light detection surface of each laser receiver 14ᵢ. The device 1 is only sensitive to measurement from such a distance N of an environment point P_{i,n} from the device 1 in which this lies within the field of view B of the respective laser receiver 14ᵢ conditioned by the reception aperture A. Conversely, targets in the near range N are thus blanked out, for example interfering clouds 33. In an exemplary embodiment, the beam expansion of the transmission laser beam 8ᵢ is 0.1-1 mrad, the reception aperture A is 1-10 mrad and the parallax PX is 5 to 50 cm, optionally 10 cm to 20 cm.

In order to further improve the near-range insensitivity of the device 1 and to increase the selectivity of the near range N, the mirror prism 17 can optionally be equipped with a rib 34 running around its periphery. The larger the diameter of the rib 34, the better the selectivity of the near range N; also, the rib 34 can be used to completely block stray light from very close targets, such as stray reflections from the housing 16 of the device 1 or from parts of the vehicle 3.

Instead of the peripheral rib 34, a peripheral groove can also be machined into the mirror prism 17 to increase the selectivity between the transmission and reception channels of the device 1. Such a groove can also be interpreted as meaning that the mirror prism 17 is composed of a sequence of several individual mirror prisms connected axially in series on one and the same axis of rotation 26, which rotate together about the axis of rotation 26.

For a high sensitivity of the device 1 and thus the measurement of distant environments 2, the largest possible reception aperture A of the laser receivers 11ᵢ is desirable, i.e. the largest possible mirror surfaces 18-25, the largest possible focusing optical units 32 and a correspondingly large compensation mirror 27. As can be seen from FIG. 4, for this purpose the laser receivers 14ᵢ, viewed in the direction of the axis of rotation 26, lie in particular at a greater distance b from the groove or rib 34 than the laser transmitters 11ᵢ with their distance a, i.e.

b>a,

optionally

b>>a.

As a result, a larger axial area of the mirror prism 17 is reserved for the reception laser beams 9ᵢ than for the transmission laser beams 8ᵢ. In contrast, the transmission laser beams 8ᵢ of the laser transmitters 11ᵢ are strongly bundled and require only very small impact points on the mirror prism 17, so that only a short axial portion of the mirror prism 17 needs to be reserved for the transmission laser beams 8.ᵢ

In order to minimise the area required for the transmission laser beams 8ᵢ on the mirror prism 17, the laser transmitters 11ᵢ are arranged with respect to the mirror prism 17 (whether with or without deflection mirror 12) in such a way that the transmission laser beams 8ᵢ cross substantially at the beam deflection device 13, i.e. in its immediate vicinity, at a crossing point Kₛ. The closer the crossing point Kₛ is to the mirror surfaces 18-25 of the mirror prism 17, the shorter the axial portion of the mirror prism 17, viewed in the direction of the axis of rotation 26, that is required for the deflection of the transmission laser beams 8ᵢ on the mirror prism 17.

The laser receivers 14ᵢ are also optionally arranged in such a way that the reception laser beams 9ᵢ cross one another, more specifically on the one hand also in the vicinity of the beam deflection device 13, in order to minimise the axial length of the mirror prism 17 required for this, and on the other hand in order to arrange the focusing optical units 32 in the crossing area K_{E} of said reception laser beams. In this way, the size of the focusing optical units 32 can be reduced to the crossing area K_{E} and thus minimised.

If all mirror surfaces 18-25 of the beam deflection device 13 are parallel to the axis of rotation 26 and the second transmission and reception directions 30₂, 31₂ are normal to the axis of rotation 26, then the second scanning fan 5₂ extends in the nadir direction from the vehicle 3, provided the axis of rotation 26 is horizontal. If the axis of rotation 26 is positioned in the direction of travel F of the vehicle 3, then in this case the scanning fan 5₂ lies in a vertical plane transverse to the direction of travel F. The first and third scanning fans 5₁, 5₃ are then inclined obliquely forwards and obliquely backwards, respectively.

In order to prevent accidental backscattering of those transmission laser beams 8ᵢ which, viewed away from the beam deflection device 13, approach the reception laser beams 9ᵢ (here: the transmission laser beam 81 and the reception laser beam 93), so that they might thus be accidentally reflected by a near target 33, the following optional measure can be taken. The laser transmitters and laser receivers 11ᵢ, 14ᵢ are oriented in such a way that the transmission and reception laser beams 8ᵢ, 9ᵢ between the beam deflection device 13 and the environment 2, which approach one another when viewed away from the beam deflection device 13 (here: viewed downwards), are at an angle to one another. In this way, the situation shown in FIG. 4, at the bottom, of a backscatter of a transmission laser pulse S_{i,n} into the reception channel of a non-associated laser receiver 14ⱼ (j≠i) can be avoided.

It is understood that the laser transmitters 11, and their transmission directions 30ᵢ (and correspondingly also the laser receivers 14ᵢ and reception directions 31ᵢ parallel thereto) then no longer lie in a plane parallel to the axis of rotation 26, but deviate therefrom. Even a slight deviation from the plane of the axis of rotation 26 is sufficient to achieve a normal distance between the skewed transmission and reception laser beams 8ᵢ, 9ⱼ in the desired near range of the device 1, which corresponds approximately to the parallax PX and thus establishes the same near-range insensitivity as the parallax PX for non-approaching, i.e. parallel, laser beams (8₂, 9₂) or diverging (8₃, 9₁) transmission and reception beams 8ᵢ, 9ᵢ.

It is understood that in all embodiments shown, instead of rotating mirror surfaces 18-25, in particular instead of a rotating mirror prism 17, periodically oscillating mirror surfaces 18-25 could also be used, for example a single oscillating mirror corresponding to one of the mirror surfaces 18, 25 in the arrangement shown in FIGS. 3 and 4.

Accordingly, the disclosed subject matter is not limited to the embodiments shown, but encompasses all variants, modifications and combinations thereof which fall within the scope of the appended claims.

What is claimed is:

1. A device for surveying an environment by time-of-flight measurement of laser beams reflected therefrom, comprising:
a beam deflection device having at least one mirror surface which can be rotated or oscillated about an axis of rotation which is non-normal to the mirror surface, which beam deflection device has a mirror prism, the prism lateral sides of which each form a mirror surface and the prism axis of which is the axis of rotation,
a first laser transmitter, which is configured to emit a first transmission laser beam in a first time-dependent transmission direction via the beam deflection device, and
a first laser receiver, which is configured to receive as a first reception laser beam the first transmission laser beam reflected by the environment and received back via the beam deflection device in a first time-dependent reception direction,
wherein the first transmission and reception directions lie parallel to one another and at a first angle to the axis of rotation at the respective transmission and reception times of the transmission and reception laser beams,
a second laser transmitter, which is configured to emit a second transmission laser beam in a second time-dependent transmission direction via the beam deflection device, and
a second laser receiver, which is configured to receive as a second reception laser beam the second transmission laser beam reflected by the environment and received back via the beam deflection device in a second time-dependent reception direction,
wherein the second transmission and reception directions lie parallel to one another and at a second angle to the axis of rotation at the respective transmission and reception times of the transmission and reception laser beams, and
wherein the first laser receiver is spaced apart from the first laser transmitter and the second laser receiver is spaced apart from the second laser transmitter, in each case in the direction of the axis of rotation.

2. The device according to claim 1, wherein the transmission laser beams cross one another substantially at the beam deflection device.

3. The device according to claim 1, wherein the reception laser beams cross one another between the beam deflection device and the laser receivers.

4. The device according to claim 3, wherein a focusing optical unit is arranged in the crossing area of the reception laser beams.

5. The device according to claim 1, wherein the first and second transmission and reception directions lie in a common plane parallel to the axis of rotation at the respective transmission and reception times of the transmission and reception laser beams.

6. The device according to claim 1, wherein the laser transmitters and laser receivers are oriented in such a way that, between the beam deflection device and the environment, those transmission and reception laser beams which, viewed away from the beam deflection device, approach one another are skewed relative to one another.

7. The device according to claim 1, wherein the mirror prism has a groove running around its periphery, wherein, viewed in the direction of the prism axis, the laser emitters lie to one side of the groove and the laser receivers to the other side of the groove.

8. The device according to claim 1, wherein the mirror prism carries a rib running around its periphery, wherein, viewed in the direction of the prism axis the laser emitters lie to one side of the rib and the laser receivers to the other side of the rib.

9. The device according to claim 8, wherein, viewed in the direction of the prism axis, the laser receivers lie at a greater distance from the rib than the laser transmitters.

10. The device according to claim 1, further comprising:
a third laser transmitter, which is configured to emit a third transmission laser beam in a third time-dependent transmission direction via the beam deflection device, and
a third laser receiver, which is configured to receive as a third reception laser beam the third transmission laser beam reflected by the environment and received back via the beam deflection device in a third time-dependent reception direction,
wherein the third transmission and reception directions lie parallel to one another and at a third angle to the axis of rotation at the respective transmission and reception times of the transmission and reception laser beams, and
wherein the third laser receiver is spaced apart from the third laser transmitter in the direction of the axis of rotation.

11. The device according to claim 10, wherein the first transmission and reception directions with the second transmission and reception directions, and also the second transmission and reception directions with the third transmission and reception directions, form an angle, in each case at the respective transmission and reception times of the transmission and reception laser beams, in the range of 1° to 30°.

12. The device according to claim 10, wherein all mirror surfaces are parallel to the axis of rotation and the second transmission and reception directions are normal to the axis of rotation.

13. The device according to claim 1, wherein the beam deflection device has at least one compensation mirror in the beam path of the reception laser beams to the laser receivers, which compensation mirror can be adjusted about an adjustment axis parallel to the axis of rotation.

14. The device according to claim 13, wherein a common compensation mirror is provided for all reception laser beams.

15. The device according to claim 1, wherein the device is mounted on an aircraft configured for a main flight direction with its axis of rotation non-normal to the main flight direction.

16. The device according to claim 1, wherein the device is mounted on an aircraft configured for a main flight direction with its axis of rotation substantially parallel to the main flight direction.

17. The device according to claim 11, wherein said angle is in the range of 5° to 15°.

18. The device according to claim 11, wherein said angle is in the range of 5° to 10°.
